(19) United States
(12) Patent Application Publication
(10) Pub. No.: US 2019/0124852 A1
(43) Pub. Date: May 2, 2019

(54) PLANT STEM SEPARATING APPARATUS

(71) Applicant: 9354-7453 QUÉBEC INC., Laval (CA)

(72) Inventors: Mario MATHURIN, St-Jean-sur-Richelieu (CA); Hubert SOUMIS-PILON, St-Jean-sur-Richelieu (CA); Carmen WARD, Massy (CA)

(21) Appl. No.: 15/580,228

(22) PCT Filed: Jul. 21, 2017
(86) PCT No.: PCT/CA2017/050879

§ 371 Date: Dec. 6, 2017

Related U.S. Application Data
(60) Provisional application No. 62/365,438, filed on Jul. 22, 2016.

(51) Int. Cl. A01G 5/00; A23N 15/02; A01G 3/033

(52) U.S. Cl. CPC A01G 5/00; A01G 2003/005; A01G 3/033; A23N 15/02

(57) ABSTRACT

A plant stem separating apparatus for separating a stem from plant portions extending from the stem is provided. The plant stem separating apparatus includes a cutter, and first and second rollers. The cutter includes a blocking member and apertures defined therein. The apertures are sized for receiving the stem therethrough and the blocking member is positioned and configured for blocking a passage of the plant portions through one of the apertures. The first and second rollers define an engagement region therebetween downstream of the aperture for receiving the stem, and are drivable to rotate in opposite directions in a forward feeding mode to grab the stem at the engagement region and pull the stem through the aperture, such that the plant portions are retained upstream of the blocking member while the stem is pulled through the aperture, thereby causing disengagement of the plant portions from the stem.

### TECHNICAL FIELD

The technical field generally relates to a plant stem separator, and more particularly concerns a plant stem separating apparatus for separating a stem from upper portions such as bud, flowers, spices or the like that extend off of the stem.

### BACKGROUND

The use of plant stem separators for separating a stem from a plant is well known. Such separators are used, for instance, for separating flowers, leaves, buds, spices or the like from the stem.

However, plant stem separators known in the art sometimes damage the flowers leaves, buds or spices, or have other shortcomings.

There is a need for an improved plant separating apparatus for separating a stem from plant portions.

### SUMMARY

In accordance with one aspect, there is provided a plant stem separating apparatus for separating a stem from plant portions extending from the stem. The plant stem separating apparatus includes a cutter, a first roller and a second roller. The cutter includes a blocking member and at least one aperture defined therein, and the at least one aperture is sized for receiving the stem therethrough. The blocking member is positioned and configured for blocking a passage of the plant portions through the at least one aperture. The first roller and the second roller define an engagement region therebetween downstream of the aperture for receiving the stem. The first and second rollers are drivable to rotate in opposite directions in a forward feeding mode to grab the stem at the engagement region and pull the stem through the aperture of the cutter, such that the plant portions are retained upstream of the blocking member while the stem is pulled through the aperture, thereby causing disengagement of the plant portions from the stem.

In some embodiments, the at least one aperture comprises a throat having an upstream end, a downstream end and a middle portion.

In some embodiments, the downstream end of the throat is raised compared to the middle portion and the upstream end.

In some embodiments, the throat is continuously tapered from the upstream end towards the downstream end.

In some embodiments, wherein the at least one aperture has an axis that is substantially horizontal.

In some embodiments, the at least one aperture comprises multiple apertures.

In some embodiments, the multiple apertures comprise apertures of different diameter.

In some embodiments, the multiple apertures comprise apertures having different diameter ranging from approximately 0.2 cm to approximately 2 cm.

In some embodiments, the multiple apertures each have a different diameter.

In some embodiments, the multiple apertures comprise a central aperture having a largest diameter, and at least one side aperture on each side of the central aperture having smaller diameters compared to the central aperture.

In some embodiments, the cutter comprises a cutting plate such that the blocking member comprises a plate and the at least one aperture is provided through the plate.

In some embodiments, the cutting plate is substantially planar and is connected to a housing of the apparatus.

In some embodiments, the cutting plate comprises a connection portion connected to a housing of the apparatus, and a recessed portion extending from the connection portion and being recessed in a generally downstream direction towards the first roller and the second roller.

In some embodiments, the recessed portion has a substantially planar surface comprising the at least one aperture.

In some embodiments, the recessed portion is positioned in spaced-apart relation to the engagement region between the first and second rollers by an engagement distance.

In some embodiments, the engagement distance ranges from 0.1 to 5 cm.

In some embodiments, wherein the engagement distance is smaller than a radius of at least one of the first and second rollers.

In some embodiments, the engagement distance extends along the axis of the at least one aperture.

In some embodiments, the recessed portion has a trapezoidal cross-section.

In some embodiments, the cutter is made as a monolithic piece.

In some embodiments, the monolithic piece is made from a steel alloy sheet.

In some embodiments, the steel alloy sheet is folded to form the recessed portion.

In some embodiments, the first and second rollers respectively have a first radius and a second radius, the first radius and the second radius ranging from 1 to 10 cm.

In some embodiments, the first radius is substantially equal to the second radius.

In some embodiments, the first roller has a first longitudinal axis and a first periphery defining a first conveying surface; and the second roller having a second longitudinal axis and a second periphery defining a second conveying surface, wherein the engagement region is defined by the first conveying surface and the second conveying surface.

In some embodiments, the first longitudinal axis and the second longitudinal axis are substantially parallel to the axis of the at least one aperture.

In some embodiments, the first roller and the second roller are horizontal.

In some embodiments, the first roller is mounted onto the second roller.

In some embodiments, the first and second rollers have substantially same lengths.

In some embodiments, the first conveying surface is in contact with the second conveying surface along an entirety of the respective first and second length.

In some embodiments, the plant stem separating apparatus further includes a motor for driving rotation of at least one of the first roller and the second roller in the forward feeding mode.

In some embodiments, the motor is coupled to both of the first roller and the second roller for driving rotation thereof.

In some embodiments, the plant stem separating apparatus further includes a driving gear coupled to the motor, the driving gear being operatively connected to the first roller and the second rollers.

In some embodiments, the first and second rollers are operable in a backward direction for removing the stem from the cutter.

In some embodiments, the first roller and the second roller are respectively mounted on a first shaft and a second shaft, the first shaft being coupled with a first gear and the second shaft being coupled with a second gear, the first and second gears being driven by a belt operatively connected to the driving gear of the motor.

In some embodiments, the plant stem separating apparatus further includes a third gear operatively connected to the driving gear and to at least one of the first roller and the second roller, such that a rotation of the driving gear engages the third gear in rotation, thereby allowing the first and second rollers to rotate in said opposite direction.

In some embodiments, the motor is operable to set a rotational speed of the driving gear, thereby allowing the driving gear, the first gear, the second gear and the third gear to rotate at said rotational speed.

In some embodiments, the plant stem separating apparatus further includes a controller operatively connected to the motor, the controller being configured for adjusting said rotational speed of the driving gear.

In some embodiments, the rotational speed of the driving gear ranges 0 to 1725 rpm.

In some embodiments, the rotational speed defines the operation speed in the forward feeding mode, the operation speed in the forward feeding mode being adjustable according to at least one characteristic of the portions of the plants.

In some embodiments, the controller is configured such that the motor is selectively switchable between the forward feeding mode and the backward mode, thereby allowing the driving gear to selectively rotate in a clockwise direction and in an anticlockwise direction near or at the engagement region.

In some embodiments, the first conveying surface and the second conveying surface are deformable near or at the engagement region to conform to the stem upon a passage of the stem therethrough.

In some embodiments, the first conveying surface and the second conveying surface both comprise an elastic material.

In some embodiments, the first conveying surface and the second conveying surface are covered with a coating made of an elastic material.

In some embodiments, the first and second rollers are made of rubber.

In some embodiments, the first conveying surface and the second conveying surface each define cylindrical outer surfaces.

In some embodiments, the plant stem separating apparatus further includes a deflector mounted downstream of the first roller and the second roller, the deflector being configured for downwardly deflecting the stem after a disengagement of the plant portions from the stem.

In some embodiments, the plant stem separating apparatus further includes a housing for enclosing the first roller and the second roller.

In some embodiments, the plant stem separating apparatus includes a frame having an upper portion and a lower portion, the upper portion being pivotally mounted to the lower portion.

In some embodiments, the motor is spring-mounted onto the upper portion of the frame.

In some embodiments, a connection portion of the cutting plate comprises an upper part and a lower part both mounted to the housing.

In some embodiments, the first roller and the second roller are positioned to directly contact each other while rotated in the forward feeding mode.

In some embodiments, multiple apertures of the cutting plate comprise a central aperture having a largest diameter and progressively smaller apertures on either side of the central aperture.

In some embodiments, the housing comprises a front portion, a back portion, two opposed side portion defining an enclosure around the rollers, and wherein the front portion comprises a front opening in which the cutting plate is located and the back portion comprises a back opening through which the stem is discharged.

In some embodiments, the plant stem separating apparatus further includes a mounting member positioned upstream and below the cutting plate, for mounting a receptacle for receiving disengaged plant portions that fall from the cutter.

In some embodiments, the multiple apertures include at least a large aperture having a diameter between 2 and 5 cm, and a small aperture having a diameter between 0.2 and 2 cm.

In some embodiments, the plant stem separating apparatus further includes a frame to which the first roller and the second roller are mounted.

In accordance with another aspect, there is provided a plant stem separating apparatus for separating a stem from plant portions extending from the stem with a pulling force. The apparatus includes a conveying system and a cuter. The conveying system includes a first rotatable roller and a second rotatable roller. The first rotatable roller has a first longitudinal axis and a first periphery defining a first conveying surface. The second rotatable roller has a second longitudinal axis and a second periphery defining a second conveying surface. The first conveying surface and the second conveying surface define a conveying passage extending from a feed end to a discharge end. The conveying system is configured for engaging the stem at the feed end and for conveying the stem along said conveying passage. The cutter is mounted near the feed end and includes an inlet configured for receiving the stem therethrough and sized for blocking the plant portions. The conveying system is configured for applying the pulling force to the stem such that the stem engages in the conveying system at the feed end and the plant portions are blocked in the inlet, thereafter separating the portion of the plant from the stem, thereby allowing to harvest the portion of the plant from the stem.

In accordance with another aspect, there is provided a plant stem separating apparatus for separating a stem from plant portions extending from the stem with a pulling force along a conveying passage. The apparatus includes a tapered hole for receiving the stem therethrough and sized for blocking the plant portions. The apparatus also includes a tail rotatable roller and a drive rotatable roller. The tail rotatable roller has a first longitudinal axis and a first periphery defining a first conveying surface. The drive rotatable roller has a second longitudinal axis and a second periphery defining a second conveying surface. The first conveying surface and the second conveying surface are in contact and define the conveying passage. The apparatus also includes a driving assembly for imparting a rotation to the drive rotatable roller about the second longitudinal axis, thereby rotatably engaging the tail rotatable roller in rotation about the first longitudinal axis. The tail rotatable roller and the drive rotatable roller exerts the pulling force onto the stem, such that the stem engages along the conveying passage end and the plant portions are blocked in the tapered hole, thereby disengaging the plant portions from the stem and allowing to separate the plant portions from the stem.

In accordance with another aspect, there is provided an assembly included a plant stem separating apparatus as described above, and further including a feeding conveyor for conveying the plant towards the cutter of the apparatus, a harvesting bin for receiving the plant portions after a disengagement of the plant portions from the stem, and an ejecting bin for receiving the stem after the disengagement of the plant portions from the stem. The harvesting bin is mounted near the cutter and the ejecting bin is mounted near the first and second rollers of the apparatus.

In accordance with another aspect, there is provided a plant stem separating method for separating a stem from plant portions extending from the stem. The method includes steps of inserting a stem into an aperture of a cutter; engaging the stem between a first and second rollers rotating in opposite direction; conveying the stem between the first and second rollers along a disengagement direction; applying a pulling force to the stem with the first a second rollers along the disengagement direction; blocking the plant portions into the aperture of the cutter; and disengaging the plant portions from the stem.

In some embodiments, the plant stem separating method further includes a step of collecting the plant portions from the aperture of the cutter.

In some embodiments, the plant stem separating method further includes a step of ejecting the stem.

In some embodiments, the plant stem separating method further includes comprising a step of deflecting the stem.

In some embodiments, the plant stem separating method includes a step of operating the first and second rollers in a forward feeding mode.

In some embodiments, the plant stem separating method includes a step of adjusting a rotational speed of the first and second rollers based on a humidity content of the plant portions to be separated from the stem.

In accordance with one aspect, there is provided a plant stem separating apparatus for separating a stem from a larger upper portion of a plant.

In some embodiments, the plant stem separating apparatus includes a support frame, a driving assembly, a controller, a shearing plate having a plurality of holes, a roller assembly and a transmission assembly. The driving assembly is affixed to the support frame. The controller is connected to the driving assembly and controls a rotational speed of the driving assembly. Each of the plurality of holes has varying dimensions and each one of the holes defines an inlet sized to receive and allow passage of the stem therethrough and block passage of the upper portion of the plant.

The roller assembly is affixed to the support frame and comprises a first roller and a second roller. The first roller and the second roller rotate about their respective axis at the rotational speed controlled by the controller and define a corresponding passage therebetween. The stem of the plant is conveyable through the corresponding passage. The transmission assembly transmits a rotational movement from the driving assembly to the roller assembly. The first and second rollers rotate at a predetermined rotational speed and, upon a capture of the stem between the first and second rollers, the stem is conveyed through the passage between the first and second rollers with a pulling force that is sufficient to shear the upper portion of the plant from the stem when upper portion enters in contact with the inlet and is blocked thereby.

According to another aspect, there is more generally provided a plant stem separating apparatus for separating a stem from a larger upper portion of a plant, the apparatus including a shearing plate and a conveying system. The shearing plate is configured for shearing the upper portion of the plant from the stem, and includes at least one aperture. The at least one aperture defines an inlet sized to receive and allow passage of the stem therethrough and block passage of the upper portion of the plant. The conveying system is positioned behind the shearing plate and is configured for conveying any portion of the stem traversing the shearing plate further through said shearing plate. The stem is conveyed by the conveying system with a pulling force that is sufficient to shear the upper portion of the plant from the stem upon the upper portion entering in contact with the inlet and being blocked thereby.

Other features will be better understood upon reading of embodiments thereof with reference to the appended drawings.

### BRIEF DESCRIPTION OF THE DRAWINGS

FIG. 1 illustrates a plant stem separating apparatus mounted on a support structure according to one embodiment.

FIG. 2 shows a side view of the plant stem separating apparatus shown in FIG. 1.

FIGS. 3A-D show different views of a cutter, such as the one provided with the plant stem separating apparatus shown in FIG. 1.

FIGS. 4A-G illustrate different configuration of the cutter according to some embodiments.

FIGS. 5A-B respectively show a front view and a side view of the plant stem separating apparatus shown in FIG. 1.

FIG. 6 illustrates the first and second rollers provided with the plant separating apparatus of FIG. 1.

FIG. 7 illustrates a plant stem separating apparatus according to another embodiment.

FIG. 8 illustrates a rear view the plant stem separating apparatus according shown in FIG. 7.

FIG. 9 illustrates a side view the plant stem separating apparatus according shown in FIG. 7.

FIG. 10 illustrates a front view the plant stem separating apparatus according shown in FIG. 7.

FIG. 11 illustrates a plant stem separating apparatus according to another embodiment.

FIG. 12 illustrates a plant stem separating apparatus assembly according to one embodiment.

FIGS. 13A-D illustrate some of the steps of a plant stem separating method according to one embodiment.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

In addition, it will be appreciated that positional descriptions such as “top”, “bottom”, “under”, “left”, “right”, “front”, “rear”, “adjacent”, “opposite”, “parallel”, “perpendicular”, “inner”, “outer”, “upper”, “lower”, “upstream”, “downstream”, “vertical”, “horizontal” and the like should, unless otherwise indicated, be taken in the context of the figures and should not be considered limiting.

In the present disclosure, the following terminology and expressions may also be used:

The terms “plant stem separating apparatus”, “bucker”, “separator”, “ripper”, “plant harvesting apparatus”, “apparatus”, derivatives and variants thereof, are generally used to refer to machines for separating a plant portion (e.g., a bud) from a stem. Such machines are typically automated or semi-automated, which may be of particular interest for residential and/or commercial applications in the harvesting industry.

The terms “buds”, “flowers”, “spices”, “leaves”, derivatives and variants thereof are used to refer to a plant portion and may encompass a broad variety of similar objects. Such plant portions are typically found in nature, but could also be the result of greenhouse and/or agricultural techniques. The plant portions may have been grown inside and/or outside. The plant portions to be separated are typically fragile and may be of particular interest to a consumer. Their harvesting may be delicate and challenging. It is to be noted that the harvesting of the plant portions may be influenced by some of the properties of the plant portions, which may in turn be related to some properties of the plant. Some properties of interest may include, but are not limited to the variety, size, shape, humidity level and/or any other properties that may have an impact on the harvesting (or, alternatively, the stem separating process) of the plant portions.

The term “stem” refers to an elongate structure of the plant to which other plant portions are connected. The stem can be a primary stem of a plant or can be a secondary smaller stem that was initially connected to a primary stem. Of particular interest in the context of the separating apparatus are stems with a length between about 20 cm and 100 cm, and a cross-sectional diameter between about 2 mm and about 15 mm, although plants with various stem dimensions can be processed.

### Plant Stem Separating Apparatus Implementations

Broadly described, there is provided a plant stem separating apparatus for separating a stem from a portion of a plant, such a larger upper portion of the plant. For instance, the apparatus can be used to separate a stem from plant portions, such as buds, extending from the stem. Some embodiments of the present invention may be useful in applications where it is desirable to remove a flower, leaves or buds from a plant without damaging the flower, leaves or buds. In some implementations, the apparatus may be used in residential applications or other smaller-scale applications. In other implementations, the apparatus may be used for commercial and industrial applications.

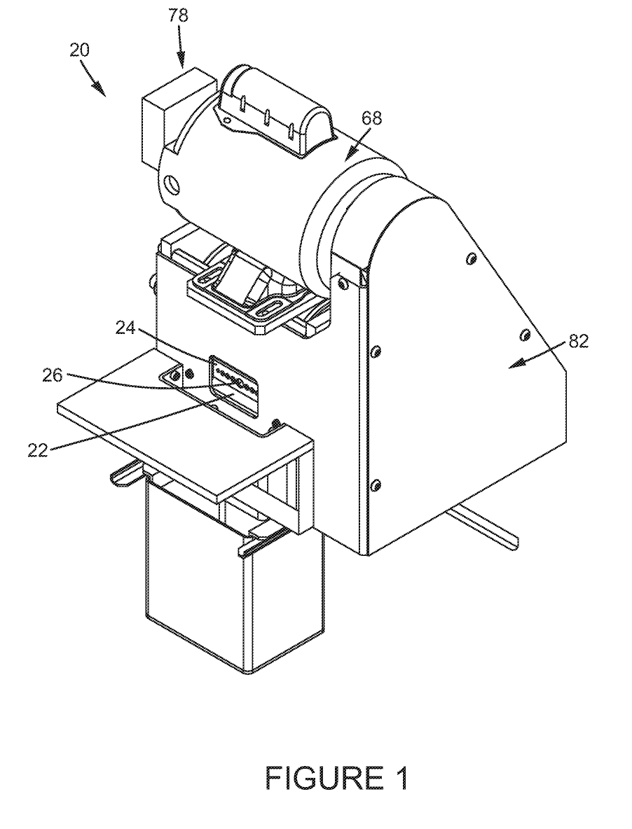

Referring to FIG. 1 a plant stem separating apparatus 20 for separating a stem from plant portions extending from the stem is shown. The plant stem separating apparatus 20 includes a cutter 22, as well as a first roller and a second roller (not shown in FIG. 1).

The cutter 22 typically includes a blocking member 24 and at least one aperture 26 defined in the blocking member 24. The aperture 26 is sized for receiving and admitting the passage of the stem therethrough, while the blocking member 24 is positioned and configured for blocking the passage of the plant portions through the aperture 26. Thus, the stem of the plant passes through the aperture 26 as the plant portions are blocked by the blocking member 24, disengaging from stem and remaining on the upstream side of the blocking member 24. In this manner, the plant portions are separated from the stem.

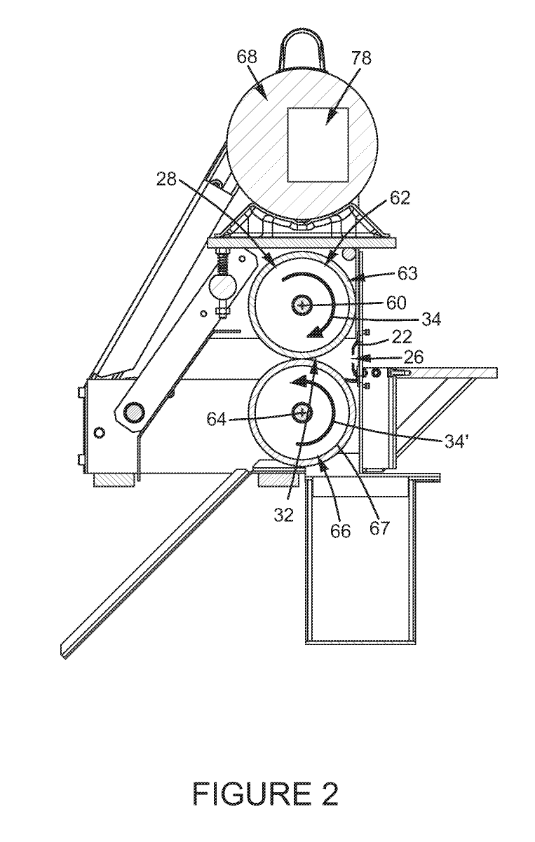

Turning now to FIG. 2, the first roller 28 and the second roller 30 define an engagement region 32 therebetween downstream of the aperture 26 for receiving the stem. The first and second rollers 28,30 are drivable to rotate in opposite directions 34,34′ in a forward feeding mode to grab the stem at the engagement region 32 and pull the stem through the aperture 26 of the cutter 22, such that the plant portions are retained upstream of the blocking member 24 while the stem is pulled through the aperture 26, thereby causing disengagement of the plant portions from the stem.

### Cutter

Embodiments of the cutter 22 will now be described in detail with reference to the drawings.

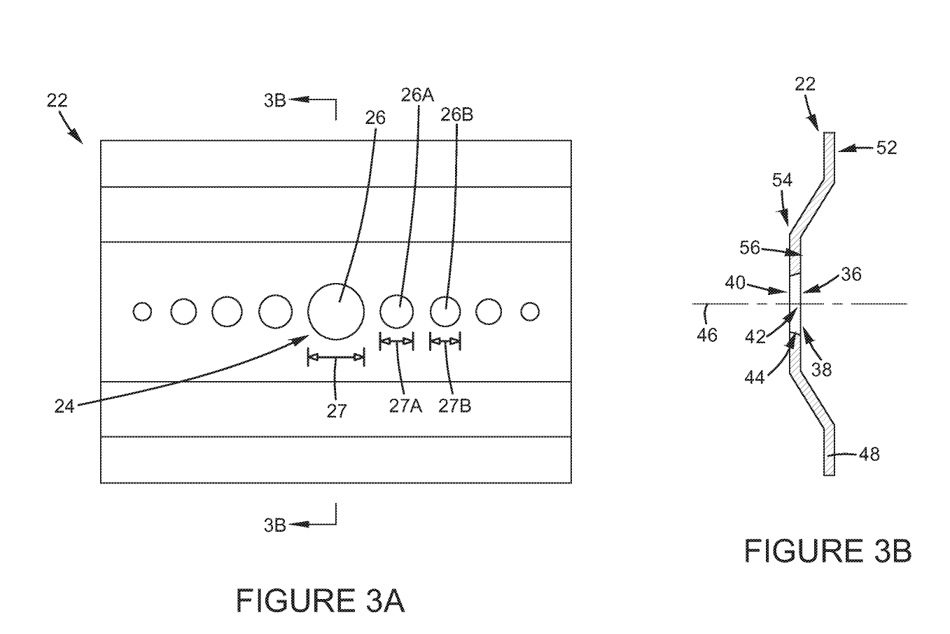

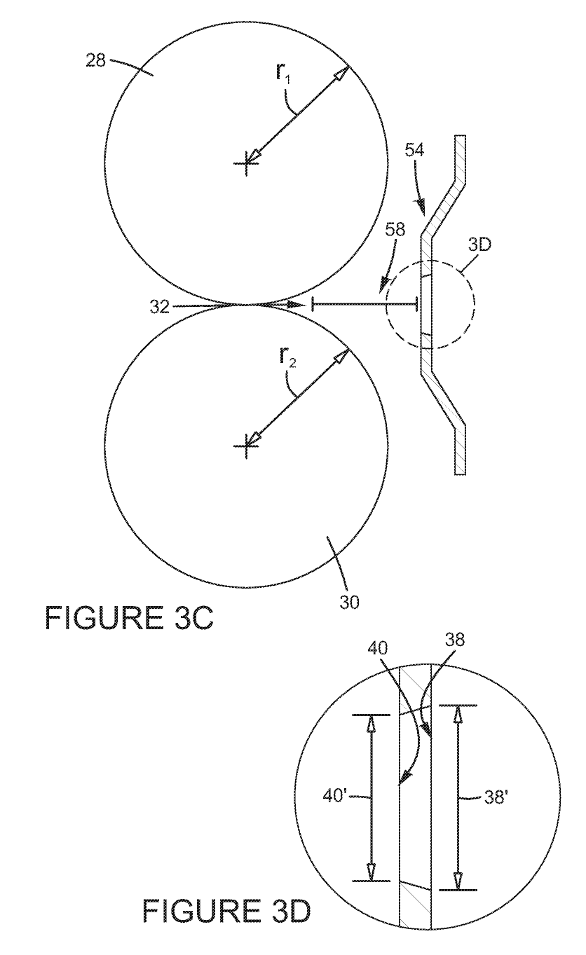

As illustrated in FIGS. 3A-C, the aperture 26 comprises a throat 36 having an upstream end 38, a downstream end 40 and a middle portion 42. In some embodiments, the aperture 26 has a generally circular cross-section and may accommodate the passage of the stem of similar shape (i.e. substantially circular in cross-section) therethrough. The aperture also has a diameter 27. It will be readily understood that other geometrical configurations of the aperture 26 cross-section may be used, such as triangular, square, rectangular, diamond or any other polygon-shaped cross-section. The aperture 26 is geometrically designed for receiving the stem from the plant, and so may be configured and sized accordingly based on a given desired application or plant type.

Referring to FIGS. 3B-D, in some embodiments the downstream end 40 may be raised compared to the upstream end 38 and the middle portion 42. More particularly, the throat 36 is continuously tapered from the upstream end 38 towards the downstream end 40. As illustrated in FIG. 3C, the upstream end 38 has an external diameter 38′ and the downstream end 40 has a nominal diameter 40′. Preferably, the nominal diameter 40′ is smaller than the external diameter 38′. Referring back to FIG. 3B, the throat 36 may also comprise an inwardly extending bevelled edge 44 provided at the downstream end 40. The extending bevelled edge 44 may be sharp so as to facilitate the disengagement of the plant portions from the stem when blocked by the blocking member 24, hence enhancing the cutting functionality of the cutter 22. The downstream end 40 could be provided with teeth, blade(s), chisel(s), or variants, alternatives, or combinations thereof, or any other structural property facilitating the disengagement of the plant portions from the stem.

Alternatively, the upstream end 38 and/or the middle portion 42 of the throat 36 could be raised compared to the downstream end 40. The throat 36, and more particularly one of the upstream end and the middle portion 42 could also comprise a cutting edge similar to the inwardly extending bevelled edge 44. In some variants, the upstream end 38 and/or the middle portion 42 may be provided with different components and/or means adapted to cutting the plant portions from the stem, such as the ones aforementioned.

In some embodiments, the throat 36 (or at least a portion thereof) and/or the edge 44 can be coated with a material with enhanced wear resistance, or can be made from the same material as the rest of the cutter.

In some implementations, the aperture 26 may be adjustable in diameter to accommodate the passage of stems of different diameters. In such implementations, the throat 36 may be provided with corresponding components or mechanisms for varying the diameter of the aperture 26. For example, the aperture 26 may be provided with a plurality of flanges selectively insertable into the aperture 26. The flanges may each have a flange diameter that is smaller that the aperture 26 diameter, so as to allow the passage of a smaller stem therethrough.

Referring now to FIGS. 3A-C, in some embodiments the aperture 26 has a longitudinal axis 46, which can be viewed as extending from a region upstream of the cutter 22 to a region downstream of the cutter 22. As illustrated, the axis 46 preferably extends in a direction that is substantially horizontal. The horizontal direction is herein understood as referring to a direction that is substantially normal to the force of gravity. Alternatively, the axis 46 could extend in other directions, such as a vertical direction generally parallel to the force of gravity. In such a vertical orientation, the configuration of the plant stem separating apparatus, and more particularly the configuration of the first and second rollers 28,30, would be modified with the rollers 28,30 being located under the cutter 22 with the blocking member 24 being orientated horizontally and the aperture axes 46 extending vertically. In this vertical arrangement, the separated plant portions may tend to accumulate on the upstream side of the blocking member 24 and would have to be brushed aside to allow additional plants to be fed into the cutter 22. It is also noted that certain components of the apparatus could have various orientations when the cutter 22 is as illustrated in the figures. For example, when the cutter 22 is positioned and configured such that the apertures 26 have axes 46 that are substantially horizontal, the downstream rollers 28,30 could be positioned horizontally (as illustrated) or vertically in a side-by-side arrangement. In this latter arrangement, the cutter 22 could have apertures 26 aligned vertically through the blocking member 24 so as to align with the engagement region 32 between the two rollers 28,30.

In some embodiments, the aperture 26 comprises multiple side apertures (exemplary represented by 26A, 26B, and so on). In some embodiments, the multiple side apertures 26A, 26B comprise apertures of different diameter 27A, 27B. In some embodiments, the different diameters 27A, 27B, range from approximately 0.1 cm to approximately 3 cm, and preferably from 0.2 to 2 cm. Each individual aperture may have a different diameter one from another or some apertures may have the same diameter as each other.

Regarding the relative sizes of the apertures, in the illustrated embodiment, the smallest aperture has a diameter of approximately 0.2 cm, while the largest aperture has a diameter of approximately 1 cm. Alternatively, the largest aperture may have a diameter of approximately 2 cm. Thus, the ratio, the ratio between the diameter of the smallest aperture and the diameter of the largest aperture can be from 1:10 to 1:5, for example. This ratio may be hence representative of the maximum stem size that can enter the apertures.

As it has been previously mentioned, the apertures (or the throat provided in the apertures) may be tapered or beveled, and so the diameter of the aperture may vary from the upstream end to the downstream end of the apertures. It is to be noted that the measurements of the diameter provided in the present description are “nominal diameter”, meaning that the term “diameter”, when used in the context of describing the size of the aperture, refers to the internal diameter of the apertures. The diameter measurements reported herein are therefore representative of the apertures' diameter as measured at the downstream end of the apertures, i.e., the narrowest point of the apertures, which in this regard is related to the maximum stem size that can enter the apertures.

The apertures are sized and configured to receive a single stem or a plurality of smaller stems simultaneously. In some scenarios, an aperture having a diameter substantially equal to the stem diameter may be used, so as the stem tightly fits into the aperture (or at least a portion of the throat, e.g., the downstream end). In other scenarios, an aperture having a diameter which is smaller or bigger than the stem diameter may be used. A smaller diameter may have a stabilizing effect on the stem, which could result, for example, in a more efficient separation of the stem from the plant portions. A bigger diameter may be preferable in the scenario in which multiple smaller stems have to be separated from plant portions. The size of the plant portions (e.g., the buds) may have to be considered when a user inserts the stem through the aperture, which may be useful, for example, for limiting and/or decreasing the number of plant portions going through the apertures. Limiting and/or decreasing the number of plant portions going through the apertures may be relevant, because such plant portions are not harvested and are therefore “lost”.

In the illustrated variant, the multiple apertures 26, 26A, 26B comprise a central aperture 26A having a given diameter, and at least one side aperture on each side of the central aperture having diameters different from the one of the central aperture. For example, the cutter 22 may comprise three, four, five or more apertures. In the illustrated variant, the cutter comprises nine apertures. In some implementations, every aperture has a different diameter from one another. In other implementations, the central aperture is the largest aperture and at least one pair of side apertures are disposed on either side of the central largest aperture. The side apertures of each pair may have, for example, the same diameter as each other. In yet other implementations, the multiple apertures 26, 26A, 26B comprise a central aperture having a largest diameter and progressively smaller apertures on either side of the central aperture. For example, the largest diameter could range between 2 and 5 cm, while the progressively smaller apertures could have a diameter ranging between 0.2 and 2 cm.

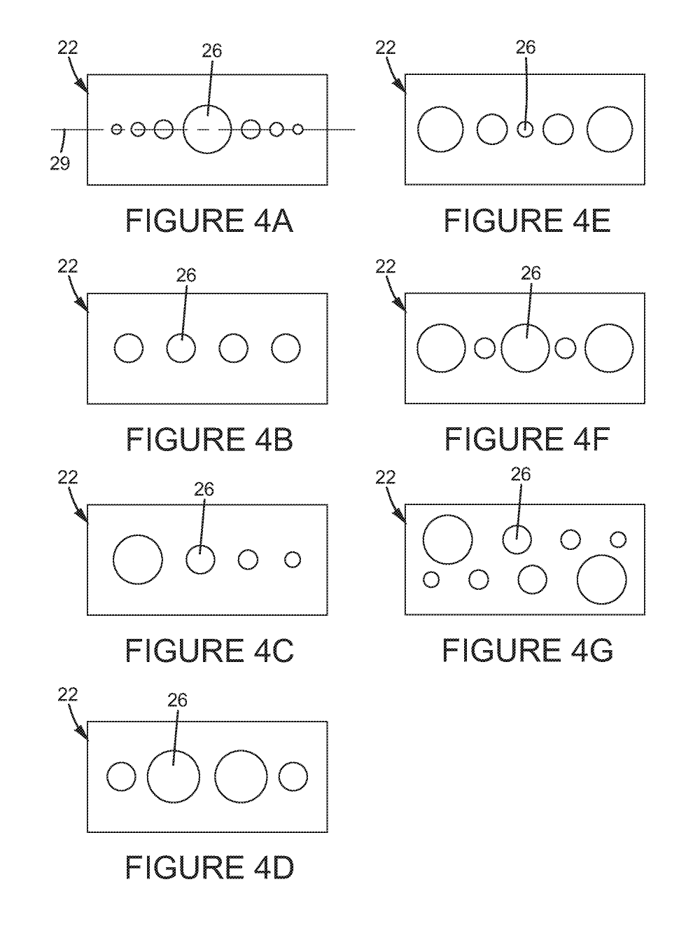

Alternatively, the cutter 22 can include various other configurations and arrangements of apertures 26, as shown in FIGS. 4A-G. Preferably, the apertures 26 are arranged along a generally horizontal line 29 such that the centers of the apertures are generally at the same elevation, which is generally aligned with the engagement region between the two rollers (not shown in FIGS. 4A-G). In this manner, the stems can be fed along a substantially level feed path from the respective apertures 26 into the engagement region between the rollers, which reduces bending or vertical deviation of the stem as it passes from the apertures 26 to the rollers.

It is also noted that the rollers are preferably sized and positioned such that the engagement region extends along a length that is spaced-apart from where the apertures are located, so as to enable stems to be fed straight into each aperture and then be engaged as different corresponding zones of the engagement region. It should be noted that multiple stems can be fed simultaneously into different apertures, and those stems are engaged at different zones along the engagement region to be pulled through by the rollers, thereby separating the plant portions of several stems at the same time.

In some implementations, and turning back to FIGS. 3A-C, the blocking member 24 of the cutter 22 may comprise a cutting plate 48. In such configurations, the blocking member 24 may consist of the cutting plate 48 and the aperture 26 may be provided through the cutting plate 48. In this regard, it should be noted that the blocking member 24 can have various configurations and structures other than a plate-like structure, as long as the blocking member can retain the plant portions on an upstream side thereof while the stem is being pulled through the aperture 26. Preferably, the blocking member 24 has a plate-like structure and thus takes the form of a cutting plate 48.

The cutting plate 48 may be substantially planar or may include a substantially planar section. In some variants, the cutting plate 48 may have a substantially square or rectangular shape. The geometrical configuration of the cutting plate 48 may be adapted according to the targeted applications. Preferably, the cutting plate 48 has a continuous upstream-facing surface with no openings therein but for the apertures 26. The continuous upstream-facing surface is preferably arranged to be substantially vertical, flat and planar. The cutting plate 48 also includes a continuous downstream-facing surface that may be substantially the same as the continuous upstream-facing surface but for its orientation. The cutting plate 48 may have a thickness that facilitates the plate to have structural rigidity and strength while enabling the apertures 26, provided as machined holes (e.g. punched holes) therethrough, to have a desired throat length and throat structural features.

The cutting plate 48 is typically is connected to a housing of the apparatus 20.

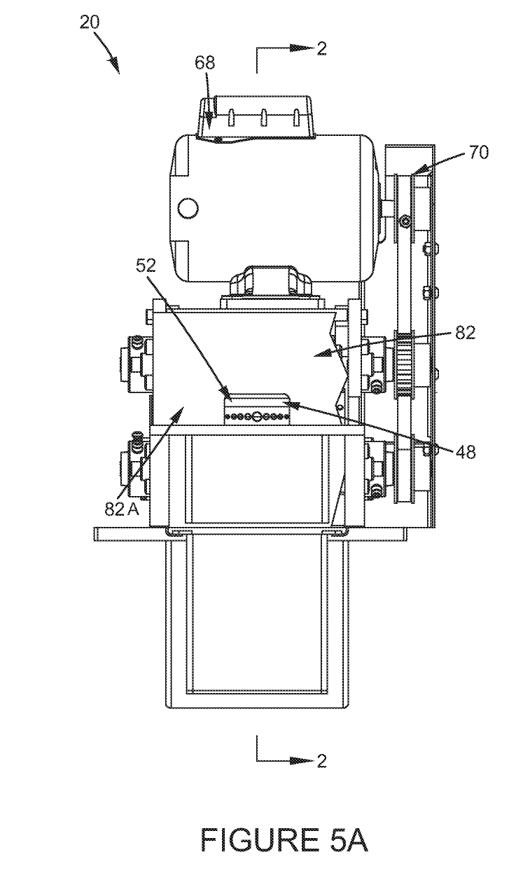

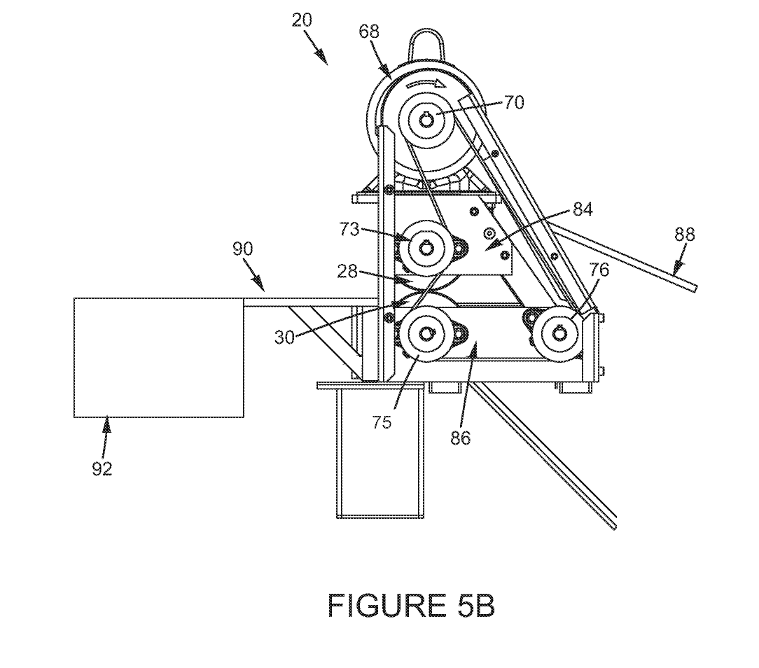

In the variant illustrated in FIG. 5A-B, the cutting plate 48 is mechanically attached to a housing 82 with corresponding connectors. The connectors could be, but are not limited to bolts, screws, nails, welding, mounting lips, or variants, combinations thereof, or any other attaching mechanism. The cutting plate 48 includes a connection portion 52 that is connected to the housing 82 of the apparatus. The connection portion 52 can include an outer perimeter portion of the cutting plate, or upper and lower portions of the cutting plate, which are secured to the housing 82. In some implementations, the cutting plate 48 is removably attached (e.g., via bolts or screws) such that it can be replaced during maintenance. In some cases, the connection portion overlays part of the housing 82 and has openings through which the connectors can pass in order to secure it in place.

Now referring back to FIGS. 3A-C, the cutting plate 48 can also include a recessed portion 54 extending from the connection portion 52. As illustrated, the recessed portion 54 is recessed in a generally downstream direction, i.e., towards the first roller 28 and the second roller 30. More particularly, the recessed portion 54 is located closer to the engagement region 32, defined by the first and second rollers 28,30, compared to the other parts of the cutting plate such as the connection portion 52.

In some embodiments, the recessed portion 54 has a trapezoidal cross-section, i.e., a shape resembling that of a trapezium.

The recessed portion 54 may have a substantially planar surface 56. The substantially planar surface 56 of the recessed portion 54 may extend in a plane parallel to the plane defined by the connection portion 52.

In this case, the recessed portion 54 preferably includes the aperture 26. Furthermore, the recessed portion 54 may be positioned in spaced-apart relation to the engagement region 32 between the first and second rollers 28,30 and separated therefrom by an engagement distance 58.

The engagement distance 58 is herein understood as the distance between the engagement region 32 and the aperture 26. More particularly, the engagement distance 58 refers to the distance between the engagement region 32 and the downstream end 40 of the throat 36. In some embodiments, the engagement distance 58 ranges from 0.1 to 5 cm, and preferably approximately 4.5 cm. The engagement distance 58 can range from 0.1 cm to 5 cm, 0.5 cm to 3 cm, or 1 cm to 2 cm, for example. The engagement distance 58 is a parameter that may be of particular interest when optimizing the capture of the stem by the first and second rollers 28,30. For example, if the engagement distance 58 is too large (e.g., above 10 cm), the stem may be less efficiently engaged between the first and second rollers 28,30, and the disengagement of the stem from the plant portions may be compromised. It will hence be understood that the engagement distance 58 is a relevant feature to consider in order to facilitate the engagement of the stem with the rollers 28, 30 and the disengagement of the plant portions from the stem.

The engagement distance 58 may vary according to various needs and can be selected, for example, according to certain characteristics of the plants or the other components of the apparatus, in order to facilitate or improve the capture of the stem by the first and second rollers 28,30.

In some cases, the engagement distance 58 is provided depending on other relevant features of the apparatus 20, such as the radii of the first and second rollers 28,30, the shape of the cutting plate 44, and the separation distance that is desired between the cutting plate 44 and the rollers 28,30. There should be a certain minimum separation distance between the rollers 28,30 and the cutting plate 44, to ensure that the former dynamic components do not contact the latter static component. Since the apparatus 20 can experience vibration as the motor 68 drives the rollers 28,30 and plants are fed and processed, the separation distance can be above a threshold based on expected vibration. For example, in some implementations, the separation distance can be at least 5 mm, 8 mm, 10 mm, 15 mm, or 20 mm, although it can be greater. When the cutting plate 44 is configured and located such that parts thereof are located in horizontally spaced relation with respect to the upstream most parts of the rollers 28,30, the separation distance can be considered to be the engagement distance minus the radius of the rollers (presuming the engagement distance is based on the contact point between the two rollers 28,30). In other words, Dₛₑₚ=D_{engagement}−Rᵣₒₗₗₑᵣ. This would be the case when the apertures 26 are at the same elevation as the engagement region 32, and the cutting plate 44 has an overall height of at least two times the radius of the rollers (when the rollers 28,30 are configured to be in contact with each other). If relatively small rollers are used (e.g., small radii), then the cutting plate 44 can more easily achieve a desired engagement distance 58 and separation distance. This follows from the equation, since as the radius decreases the two distances approach each other. However, for larger rollers (i.e., larger radii) maintaining a desired separation distance can lead to an undesirably larger engagement distance. Thus, for larger rollers, the recessed portion 54 can be provided and configured to achieve the desired engagement distance. In such cases, the recessed portion 54 can enable positioning the apertures close to the engagement region while positioning the other parts of the cutting plate sufficient away from the rollers.

In some implementations, the engagement distance 58 may be smaller than a radius r₁ and/or r₂ of at least one of the first and second rollers 28,30.

In the illustrated embodiments, the engagement distance 58 extends along the axis 46 of the at least one aperture 26. As it has been previously mentioned, the first and second rollers 28,30 are, in the depicted variants, in a horizontal configuration, and so the axis 46 is substantially horizontal. In such a configuration, the engagement distance 58 can be considered as a horizontal distance.

In some embodiments, the cutter 22 is made as a monolithic piece. The monolithic piece may be made, for example, from a steel alloy sheet. The steel alloy sheet may be folded to form the recessed portion 54. Other suitable, rust-resistant or corrosion-resistant materials could be used, preferably those that enable a folding or bending therefor. As it will be understood, the sheet may be made from any material that can be folded or bended, or, alternatively, plastically deformed and remain as such once folded, deformed and/or bended. For example, and without being limiting, the sheet could be formed from plastic, thermoplastic (e.g., acrylic), metal (e.g. aluminum, brass), or combinations thereof or any other material. In some configurations, it may be preferable to form the monolithic piece from a rustproof material or to provide the monolithic piece with a rustproof coating. Other coatings can be provided on all or parts of the cutting plate 44 to reduce wear, increase cutting functionality, reinforce attachment point, or facilitate other functions.

### First Roller and Second Roller

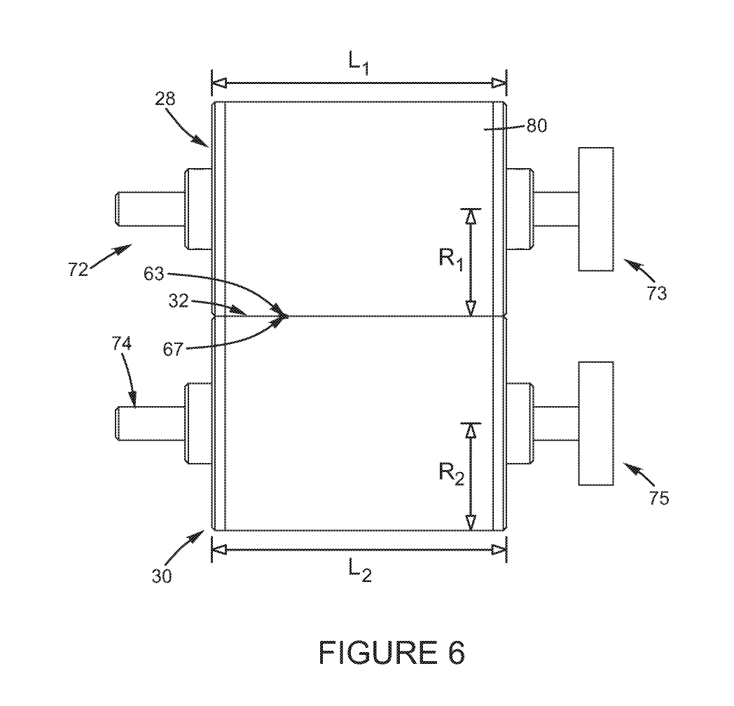

Now referring to FIGS. 2, 5B and 6, the first and second rollers 28,30 will be described in detail. It is noted that the first and second rollers 28, 30 can be said to be part of a roller system or a conveying system, as will be described below.

In some embodiments, the first and second rollers respectively have a first radius r₁ and a second radius r₂. The first radius r₁ and the second radius r₂ typically range from 3 to 10 cm. Preferably, the first and second radii r₁,r₂ are approximately equal to 5 cm. In the illustrated variant, the first radius r₁ is substantially equal to the second radius r₂. It is also noted that the radii r₁,r₂ can be provided in accordance with other dimensions of the apparatus 20, e.g., with the aperture 26 diameters, to facilitate processing of certain plant types or sizes. For example, when the apertures 26 are sized to enable accommodating stems of at most 10 mm, the rollers can be sized to have radii of between 40 mm and 60 mm, or between 45 mm and 55 mm. Thus, the ratio between the maximum stem size that can enter an aperture 26 and the roller radii r₁,r₂ can be from 1:6 to 1:4, for example.

In some embodiments, the first roller 28 has a first longitudinal axis 60 and a first periphery 62. The first periphery 62 defines a first conveying surface 63. The first conveying surface 63 more particularly refers to the outer surface of the first roller 28. Quite similarly, the second roller 30 also has a second longitudinal axis 64 and a second periphery 66 defining a second conveying surface 67. The second conveying surface 67 more particularly refers to the outer surface of the second roller 30.

The engagement region 32 is defined by the first conveying surface 63 and the second conveying surface 67. In operation, the first conveying surface 63 is in contact with the stem passing through the engagement region 32. More specifically, the first roller 28 is in contact with the stem near or at a six o'clock position. The second conveying surface 67 is also in contact with the stem passing through the engagement region 32 and more specifically, the second roller 30 is in contact with the stem near or at a twelve o'clock position. In operation, the first roller 28 and the second roller 30 are positioned to directly contact each other while rotated in the forward feeding mode (i.e., the mode in which the stem is conveyed along the engagement region 32 and is thereafter disengaged from the plant portions).

In some embodiments, the first longitudinal axis 60 of the first roller 28 and the second longitudinal axis 64 of the second roller 30 are substantially perpendicular to the axis 46 of the aperture 26, and such that the aperture 26 is substantially aligned with the engagement region 32 provided between the first and second rollers 28,30.

As it has been previously mentioned, the first roller 28 and the second roller 30 may be in various orientations, e.g., in a horizontal or in a vertical configuration. In the illustrated embodiment, the first and second rollers 28,30 are in the horizontal configuration, meaning that the first and second longitudinal axes 60,64 are extending in a direction substantially normal to the force of gravity. Alternatively, the first and second rollers 28,30 could be used in the vertical configuration.

In the horizontal configuration, the first roller 28 may be mounted to be in contact with the second roller 30. The first and second longitudinal axes 60, 64 may be aligned so that the centers of the cross-section of the first and second rollers 28,30 are aligned one above the other. In such a configuration, the first and second rollers 28,30 can be said to be aligned along a vertical axis. Alternatively, there could a shift between the center of the first roller 28 and the center of the second roller 30. In such an alternative configuration, the first and second rollers 28,30 would not be aligned in the vertical axis, which could be useful, for example, when using rollers of different dimensions (e.g. the diameter of the first roller 28 is smaller than the diameter of the second roller 30, or vice-versa), or when it is desirable in certain applications.

The first and second rollers 28, 30 are further characterized by respective first and second lengths L₁,L₂. For example, the corresponding first and second lengths L₁,L₂ could be substantially equal, as in the illustrated embodiment. It will be readily understood that the corresponding first and second lengths L₁,L₂ could alternatively be different from one another and the first and second rollers 28,30 could have appropriate dimensions according to certain applications.

In the scenario in which the first and second rollers 28,30 are in contact, the first conveying surface 63 may be in direct contact with the second conveying surface 67 along an entirety of the corresponding first and second lengths L₁,L₂. Alternatively, the first and second conveying surfaces 63,67 could be in direct contact with one another along a portion of the corresponding first and second lengths L₁,L₂, for example when the lengths L₁,L₂ of the first and second rollers 28,30 are not identical. Alternatively, the rollers 28,30 could be maintained in spaced-apart relation froth each other, in which case the roller spacing would be less than the stem diameter to enable the stem to be gripped and pulled through the engagement region 32.

In some embodiments, the first conveying surface 63 and/or the second conveying surface 67 are deformable to conform to the stem upon a passage of the stem between the first and second conveying surface 63,67. For example, the first conveying surface 63 and the second conveying surface 67 could both comprise an elastic material. In addition, the first conveying surface 63 and the second conveying surface 67 could be covered with a coating made of an elastic material 80. The elastic material 80 could be, for example, rubber, which could be either synthetic or natural based rubber. It will be readily understood that many different materials could be used, for parts of the rollers 28,30. The outer surfaces of the rollers are preferably composed of a polymeric material that is deformable, resilient, and sticky to facilitate grabbing and pulling the stem while reversibly deforming around the stem as it passes through the engagement region.

As illustrated, the first conveying surface 63 and the second conveying surface 67 each define cylindrical outer surfaces, meaning that they each have a substantially circular cross-section. Cylindrical surfaces are preferred in this application. It will however be easily recognized that the shape of the outer surfaces of the first and second conveying surfaces 63,67 may vary according to certain applications or constructions of the apparatus 20. For example, the first and/or second conveying surfaces 63,67 could define a spherical outer surface. Preferably, the outer surfaces of the rollers 28,30 are substantially smooth, regular and continuous, such as cylindrical surfaces. In some alternative implementations, the outer surfaces of the rollers 28,30 can have structural forms such as teeth, grooves, and the like.

Preferably, the first and second rollers 28,30 are each one piece integral rollers. In alternate embodiments, the first and second rollers 28,30 could each be replaced a plurality of smaller rollers connected to each other in end-to-end fashion, so as to form corresponding assembled rollers.

### Motor and Driving Gear

In some embodiments, the plant stem separating apparatus 20 further includes a motor 68 for driving rotation of at least one of the first roller 28 and the second roller 30 in the forward feeding mode. The motor 68 may be similar to various motors designed for rotation applications, and can be selected and/or configured to be operable at one or more speeds, generate a given amount of power and/or any other properties generally associated to motors.

The motor 68 may be coupled to both of the first roller 28 and the second roller 30 for driving rotation thereof. It is to be noted that the motor may be directly or indirectly coupled to the first and second rollers 28,30, and additional mechanical and/or electrical components may be provided for driving rotation of the first and second rollers 28,30. Such additional components could include, for example, gear, sheaves, chain, pulley, rope, shaft, rod, flange, attaching means, switch, resistors, battery, transistors, variants, combinations thereof and/or any other components required to impart a rotational movement to the first and second rollers 28,30

The plant stem separating apparatus 20 includes, in some embodiments, a driving gear 70 coupled to the motor 68. The driving gear 70 is operatively connected to the first roller 28 and the second roller 30. In alternate embodiments, the driving gear 70 could be replaced by a mechanical equivalent, such as pulley, sheave, or the like.

In some embodiments, the first and second rollers 28,30 are operable in a backward mode, as well as the forward feeding mode previously described. Operation of the apparatus 20 in the backward mode may be useful for removing a stem or other debris from the cutter 22, for example when a stem is stuck in the aperture 26 (e.g., in the scenario in which the stem is bigger than the aperture 26 selected by the user).

In the illustrated embodiment, the first roller 28 and the second roller 30 are respectively mounted on a first shaft 72 and a second shaft 74. As illustrated, the first shaft 72 is coupled with a corresponding first gear 73 and the second shaft 74 is coupled with a corresponding second gear 75. In this configuration, the first and second gears 73,75 can be driven by a belt operatively connected to the driving gear 70 of the motor 68. The belt forms a closed-path loop defined by the driving gear 70 and the first and second gears 73,75.

The plant stem separating 20 apparatus may further include a third gear 76 operatively connected to the driving gear 70 and to at least one of the first roller and the second roller 28,30 (e.g., through the first and/or second gears 73,75, if any). In operation, a rotation of the driving gear 70 engages the third gear 76 in rotation, thereby rotatably engaging the first and second rollers 28,30. The configuration of the first and second rollers 28,30 and the gears presented in the current description (e.g., the driving gear 70, the first gear 73, the second gear 75 and the third gear 76) is such that the first and second rollers 28,30 rotate in opposite direction.

The motor 68 may be operable to set a rotational speed of the driving gear 70, thereby allowing the driving gear 70, the first gear 73, the second gear 75 and the third gear 76 to rotate at the rotational speed. In operation, the rotational speed is typically set to remain constant, but different components and/or means could be used to ramp-up and/or ramp-off the rotational speed if required by a targeted application.

### Controller

In some embodiments, the plant stem separating apparatus 20 further includes a controller 78 operatively connected to the motor 68, as shown in FIG. 1. The controller 78 is configured for adjusting the rotational speed of the driving gear 70. As such, the controller 78 controls the rotational speed of the first, second and third gears 73,75,76, and thus the rotational speed of the first and second rollers 28,30. In this configuration, the controller 78 indirectly controls the rotational speed of the first and second rollers 28,30, because the rotation of the first and second rollers 28, 30 is imparted through the rotation of the driving gear 70. In other embodiments, an individual controller may be operatively connected to each one of the first, second and third gears 73,75,76.

The rotational speed attainable by the driving gear 70 may range from 0 to 1725 rpm. The rotational speed can range from 1000 rpm to 1600 rpm, 1100 rpm to 1500 rpm or 1200 to 1400 rpm, for example. The controller 78 may be provided with an adjustable knob for selecting a rotational speed value included in those ranges. Of course, this range depends on the characteristics of the motor 68 (e.g. the power), and is not a limitation of the controller 78 itself.

Because the driving gear 70 is coupled to the first and second rollers 28,30, the rotational speed may be used to define the operation speed in the forward feeding mode. In some embodiments, the operation speed in the forward feeding mode is adjustable according to at least one characteristic of the plants. For example, if the portions of the plants are dry, the rotational speed may be adjusted to be slower, and could for example range in the 400 rpm to 1000 rpm range, and preferably about in the 600 to 800 rpm if the plant portions are dry (e.g. more than three hours after their harvesting). On the contrary, if the portions of the plants are humid (i.e. if the portions of the plants are still freshly harvested, e.g. less than three hours), the rotational speed may be adjusted to be faster, and could for example range in the 1200 to 1400 rpm range. The ranges may also be related the motor 68 maximum rotational speed. For example, if the plant portions are fresh, the motor 68 may be operated at about 70 to 80% of its maximum rotational speed and about 50% of its maximum speed if the plant portions are dry. It is understood that the rotational speed is adjustable so that the plant stem separating apparatus 20 can be used in a broad variety of applications, and adaptable to the different characteristics the portions of the plant may have.

The controller 78 may be configured such that the motor 68 is selectively switchable between the forward feeding mode and the backward mode. The driving gear 70 may then be selectively rotated in a clockwise direction and in an anticlockwise direction near or at the engagement region 32. For example, the clockwise direction may be associated to the forward feeding mode, while the anticlockwise direction may be associated to the backward mode (or vice-versa).

### Housing and Support Frame

Now turning to FIGS. 1 and 5A-B, the housing 82 is configured for enclosing the first roller 28 and the second roller 30, as well as other components of the apparatus 20. The housing 82 may be embodied by plates assembled together to provide a structure for enclosing the first and second rollers 28,30, as well as the shafts onto which the rollers 28,30 are mounted.

In some embodiments, the connection portion 52 of the cutting plate 48 comprises an upper part and a lower part which are both mounted to the housing 82.

The housing 82 may comprise a front portion 82A, a back portion and two opposed side portions defining an enclosure around the first and second rollers 28,30. The front portion 82A may comprise a front opening in which the cutting plate 48 is located. The back portion may comprise a back opening through which the stem is discharged.

The plant stem separating apparatus 20 may also include a frame which comprises an upper portion 84 and a lower portion 86. In the illustrated variant, the upper portion 84 is pivotally mounted to the lower portion 86. More particularly, the upper and lower portions 84,86 are mechanically joined by a shaft about which may pivot the upper portion 84. This configuration of the frame may be useful in the situations in which a user needs to “open” the frame, for example to access one of the first and second rollers 28,30 (e.g. instance during maintenance or cleaning operations). The housing 82 may further enclose the frame or a portion of the frame.

In some embodiments, the first roller 28 is mounted and mechanically attached to the upper portion 84 of the frame, while the second roller 30 is mounted and mechanically attached to the lower portion 86. In this configuration, pivoting the upper portion 84 about the shaft joining the upper and lower portions 84, 86 not only allows “opening” the frame, but further allows disengaging the first roller 28 from the second roller 30 (or more particularly their respective conveying surfaces 63,67).

In the illustrated variant, the motor 68 is spring-mounted onto the shafts provided in the upper portion 84 of the frame. The mass of the motor 68 exerts a downward force upon the first roller 28, and so helps maintaining the direct contact between the first and second rollers 28,30 along their respective lengths L₁, L₂.

In some embodiments, the plant stem separating apparatus 20 further includes a mounting member 90 positioned upstream and below the cutting plate 44 for mounting a receptacle 92. The receptacle 92, also referred to as a “harvesting bin” is sized and configured for receiving disengaged plant portions that fall from the cutter 22.

In some embodiments, the plant stem separating apparatus 20 further includes a deflector 88 mounted downstream of the first and second rollers 28,30. In the illustrated variant, the deflector mounted near or at the lower portion 86 of the frame or could alternatively be mounted onto the housing 82. The deflector 88 is configured for downwardly deflecting the stem after a disengagement of the bud from the stem, hence facilitating the collection of the disengaged stem.

In one implementation (not shown into the Figures), a plant stem separating apparatus for separating a bud from a stem with a pulling force is provided. The apparatus includes a conveying system and a cutter. In this implementation, the conveying system includes a first rotatable roller and a second rotatable roller. The first rotatable roller has a first longitudinal axis and a first periphery defining a first conveying surface. The second rotatable roller has a second longitudinal axis and a second periphery defining a second conveying surface. The first conveying surface and the second conveying surface define a conveying passage extending from a feed end to a discharge end. The conveying system is configured for engaging the stem at the feed end and for conveying the stem along the conveying passage. The cutter is mounted near the feed end and includes an inlet configured for receiving the stem therethrough and sized for blocking the bud. The conveying system is configured for applying the pulling force to the stem such that the stem engages in the conveying system at the feed end and the bud is blocked in the inlet, thereafter separating the portion of the plant from the stem, thereby allowing to harvest the portion of the plant from the stem.

### Other Implementations and Embodiments

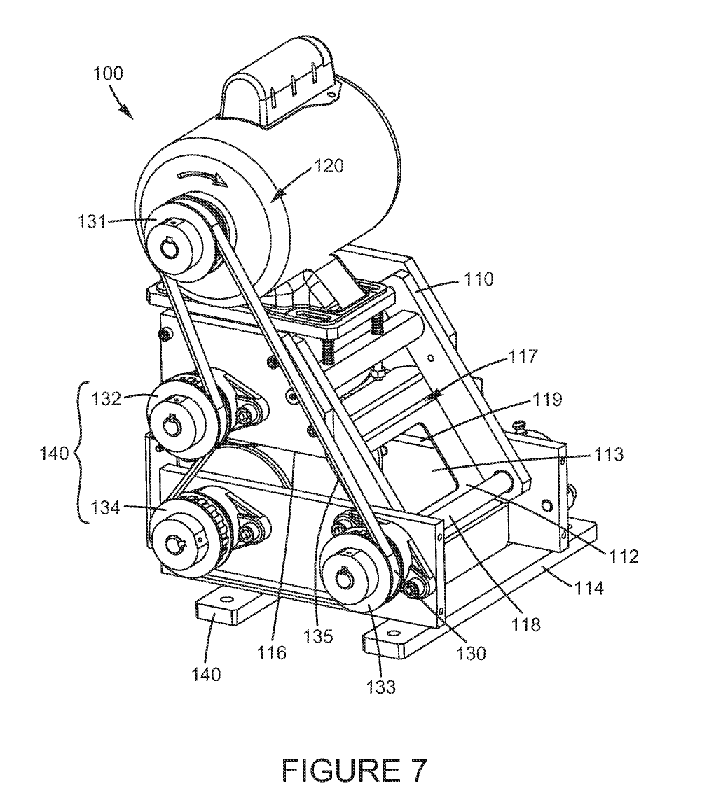

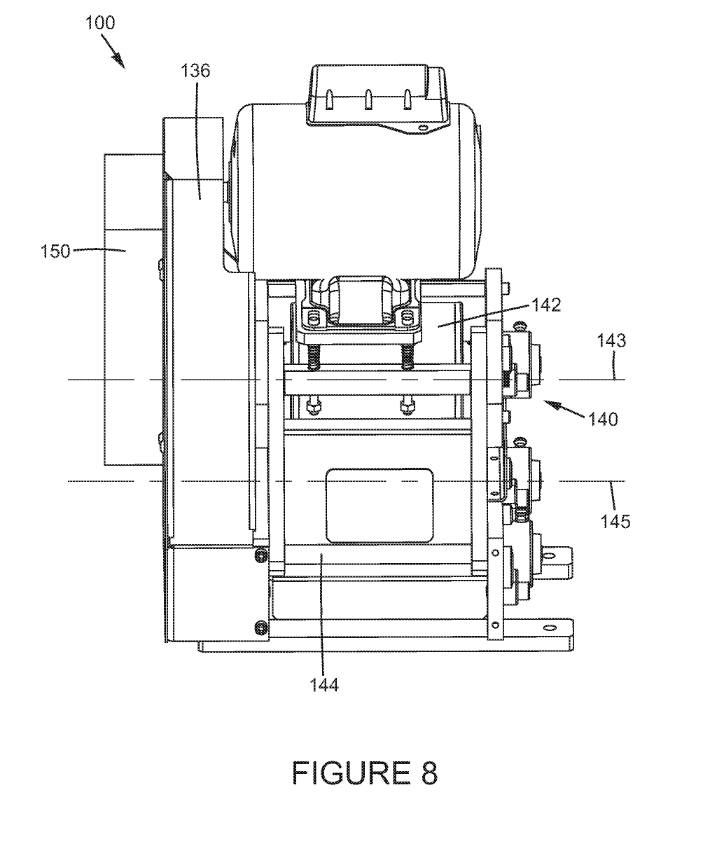

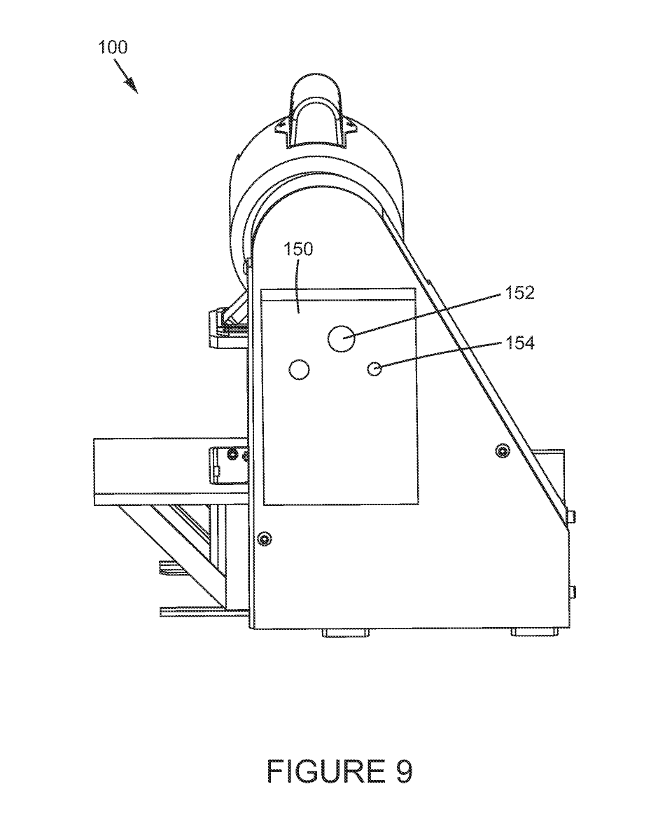

Referring now to FIGS. 7 to 10, one embodiment of the plant stem separating apparatus 100 for separating a stem from a larger upper portion of a plant is shown.

In this embodiment, there the plant stem separating 100 apparatus may comprise a support frame 110, a driving assembly 120, a controller 150, a plurality of holes 160 of varying dimensions, a roller assembly 140 and a transmission assembly 130. The roller assembly 140 may for example comprise a first roller 142 and a second roller 144. Upon a capture of the stem between the first and second rollers 142, 144, the stem may be conveyed through a passage between the first and second rollers 142,144 with a pulling force that is sufficient to shear the upper portion of the plant from the stem.

The support frame 110 has an opened side 112. The support frame can be made of metal, plastic, polymer, combinations thereof, or any other suitable materials having the desired structural properties. It will be understood that the support frame 110 is embodied by a plurality of components assembled together defining a space that admits the insertion of a plurality of components.

In the illustrated embodiment, the support frame 110 includes a support base 114 and sidewalls 116. The sidewalls 116 are mounted onto the support base 114 and are connected one to each other with a fixing means 117. The fixing means 117 comprise two fixing shafts 118 connected to two flattened fixing rods 119. Each one of the two fixing shafts 118 is parallel with respect with the other one of the two fixing shafts 118 and the fixing means 117 define an O-shaped structure.

In the illustrated embodiment, one sidewall is a visually transparent plastic sheet having an ejecting hole 113 for allowing the injection of the stem after its disengagement from the portions of the plant.

The driving assembly 120 is mounted to the support frame 110. The driving assembly 120 can be an electric motor, a gas engine, or any assembly which converts one form of energy into mechanical energy.

The transmission assembly 130 comprises a motor gear 131, a first roller gear 132, an optional supplementary gear 133, a second roller gear 134 and a belt 135 defining a closed-loop path with a motor section and a roller assembly section. The belt 135 is engaged with the motor gear 131 in the motor section and is engaged with the first roller gear 132, the optional supplementary gear 133 and the second roller gear 134 in the roller assembly section. A rotation of the motor gear 131 drives the belt 135 along the closed-loop path and rotatably engages the first roller gear 132, the optional supplementary gear 133 and the second roller gear 134 in rotation.

Alternatively, the transmission assembly 130 could solely include the motor gear 131, the first roller gear 132 and the second roller gear 132.

Alternatively, the transmission assembly 130 may include pulleys instead of gears. In this implementation, the transmission assembly 130 comprises a first roller pulley 132, an optional supplementary pulley 133 and a second roller pulley 134. Furthermore, the transmission assembly 130 may include chains instead of belts. It will be understood that the transmission assembly may include different gears and/or pulleys and different belts and/or chains, and is configured for imparting a rotational movement to the

The plant stem separating apparatus 100 may comprise a cover 136 for protecting the transmission assembly 130, which may be useful, for example, for preventing injuries to an operator. The cover 136 can be made from metal, plastic, polymer, combinations thereof, or any other suitable materials allowing protecting the transmission assembly 130. The cover may be embodied by a single piece of material or by a plurality of elements assembled altogether.

The roller assembly 140 includes a first roller 142 and a second roller 144. The first and second rollers 142, 144 are mounted into the support frame 110. In the illustrated embodiment, the first and second rollers 142, 144 are parallel one with respect to another. Each one of the first and second rollers 142, 144 are mounted on a rotatable shaft, such that the first and second rollers 142, 144 can rotate around their respective rotation axis 143, 145 in opposite direction. For example, if the first roller 142 rotates in the clockwise direction the second roller 244 rotates in the anticlockwise direction.

A conveying passage 141 is provided between the first and second rollers 142, 144, to allow passage of the stem between the first and second rollers 142, 144. In some embodiment, the first and second rollers 142,144 are in direct contact and may be deformed to allow the passage of the along the conveying passage 141.

The first and second rollers 142, 144 are made from rubber or provide a rubber interface surface with the stem. Alternatively, the first and second rollers 142, 144 can be made from polymer, plastic, or any other suitable material having the required mechanical properties (e.g. elastic properties). The resilient nature of the rubber rollers 142, 144 may accommodate varying stem diameters passing through a same passage.

In operation, the motor gear 131 rotates and engages the belt 135 along the closed loop path, to engage the first roller gear 132, the optional supplementary gear 133 and the second roller gear 234, which in turn engage the first and second rollers 142, 144 in in the opposite direction.

The controller 150 may be operatively connected to the driving assembly 120 for controlling a rotational speed of the driving assembly 120. The controller 150 typically comprises an adjustable knob 152 for selecting a value of the rotational speed of the driving assembly 120 and an activation switch 154 for activating the driving assembly 120. It will be understood that the controller 150 is embodied by a plurality of electronic components assembled altogether to control the rotational speed of the driving assembly 120. Alternatively, the controller 150 may comprise a plurality of indicators for indicating values of different parameters, such as the speed, the power, the exerted force, and the like.

Alternatively, the plant stem separating apparatus 100 may comprise a driving assembly 120 having a first and a second motor. In this implementation, the first motor imparts rotation to one of the first and second rollers 142, 144, and the second motor imparts rotation to the other one of the first and second rollers 142, 144. For example, and without being limitative, the first motor may rotatably engage the first roller 142, while the second motor may rotatably engage the second roller 144.

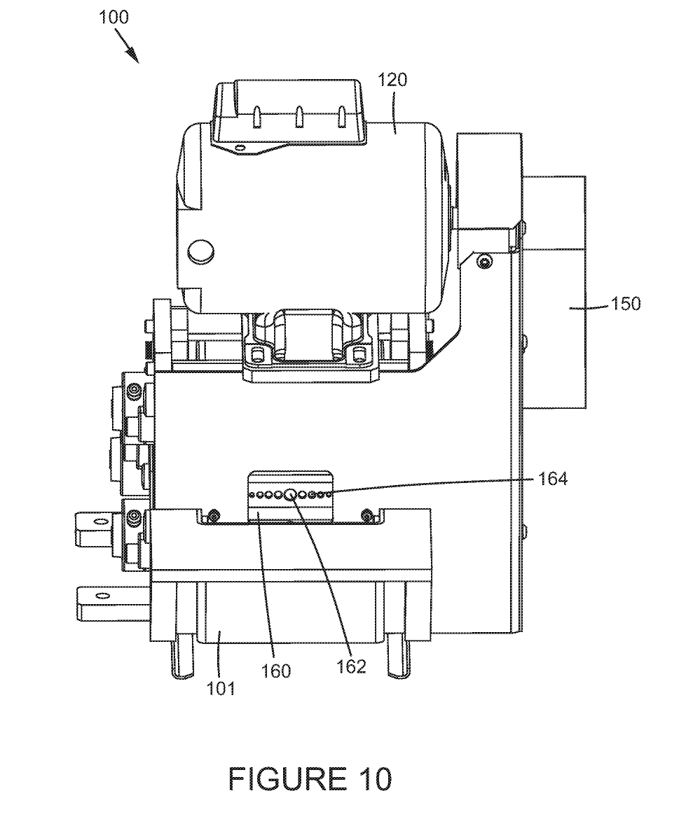

In the illustrated embodiment of FIG. 10, the plant stem separating apparatus 100 comprises a front chute 101 for collecting the upper portion of the plant after separation of the upper portion of the plant from the stem of the plant.

The plant stem separating apparatus 100 according to this embodiment further comprises a shearing plate having a plurality of holes 160 of varying dimensions, defining inlets 162, 164 to receive and allow passage of the stem through the conveying passage 141 and block passage of the upper portion of the plant. Dimensions of the inlets 162, 164 are configured for allowing the passage of stem of different diameters, while blocking the larger upper portion of the plant. In some variants, the plurality of holes 160 and the inlets 162, 164 can be beveled to help with the insertion of the stem into the plurality of holes 160 and facilitate the separation of the upper portion of the plant from the stem of the plant.

### Drive and Tail Rollers Implementation

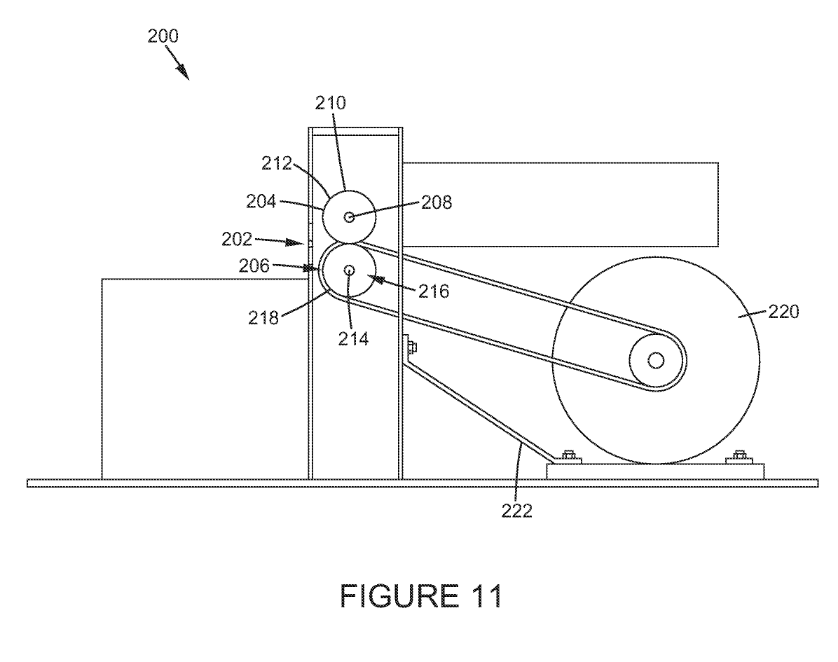

Turning now to FIG. 11, another embodiment of a plant stem separating apparatus 200 for separating a bud from a stem with a pulling force along a conveying passage. The apparatus includes a tapered hole 202 for receiving the stem therethrough and sized for blocking the bud. The apparatus also includes a tail rotatable roller 204 and a drive rotatable roller 206.

The tail rotatable roller 204 has a first longitudinal axis 208 and a first periphery 210 defining a first conveying surface 212. The drive rotatable roller 206 has a second longitudinal axis 214 and a second periphery 216 defining a second conveying surface 218. The first conveying surface 212 and the second conveying surface 218 are in contact and define the conveying passage. The apparatus 200 also includes a driving assembly 220 for imparting a rotation to the drive rotatable roller 206 about the second longitudinal axis 214, thereby rotatably engaging the tail rotatable roller 204 in rotation about the first longitudinal axis 208. The tail rotatable roller 204 and the drive rotatable roller 206 exerts the pulling force onto the stem, such that the stem engages along the conveying passage and the bud is blocked in the tapered hole 202, thereby disengaging the bud from the stem and allowing to separate the bud from the stem.

In such configuration, the driving assembly 220 may be embodied by an external motor imparting the rotational movement to the drive rotatable roller 206. A tension-maintaining mechanism 222 may further be provided to ensure that the first conveying surface 212 and the second conveying surface 218 remains in direct contact, so as to exert the pulling force.

### Plant Stem Separating Assembly

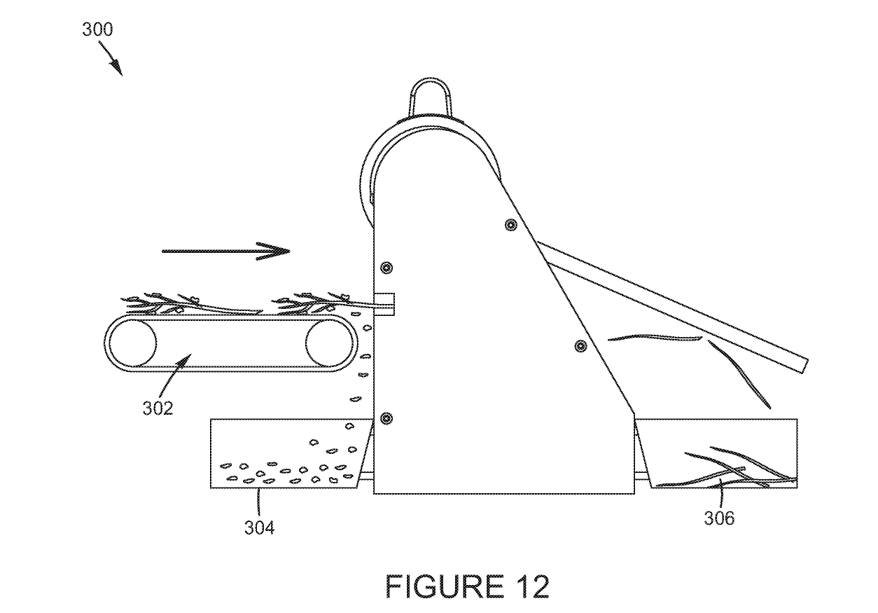

Now turning to FIG. 12, an assembly 300 including a plant stem separating apparatus as described above is shown.

The assembly includes a feeding conveyor 302 for conveying the plant towards the cutter of the apparatus.

A harvesting bin 304 may be provided for receiving the bud after a disengagement of the bud from the stem. The harvesting bin 304 may be, for example, a receptacle for receiving and temporarily storing the plant portions.

An ejecting bin 306 may be provided for receiving the stem after the disengagement of the bud from the stem. The harvesting bin is mounted near the cutter (i.e. upstream of the cutter of the apparatus) and the ejecting bin is mounted near the first and second rollers of the apparatus (i.e. downstream of the first and second rollers of the apparatus).

### Plant Stem Separating Method

A plant stem separating method for separating a bud from a stem may also be provided. The method uses the plant stem separating apparatus as described above and generally includes at least some of the following steps: inserting a stem into an aperture of a cutter; engaging the stem between a first and second rollers rotating in opposite direction; conveying the stem between the first and second rollers along a disengagement direction; applying a pulling force to the stem with the first a second rollers along the disengagement direction; blocking the bud into the aperture of the cutter; and disengaging the bud from the stem. In some embodiments, the plant stem separating method may further include at least one of the following steps: collecting the bud from the aperture of the cutter, ejecting the stem and/or deflecting the stem. In some embodiments, the plant stem separating method includes a step of operating the first and second rollers in a forward feeding mode. In some embodiments, the plant stem separating method includes a step of adjusting a rotational speed of the first and second rollers based on a humidity content of the plant portions to be separated from the stem.

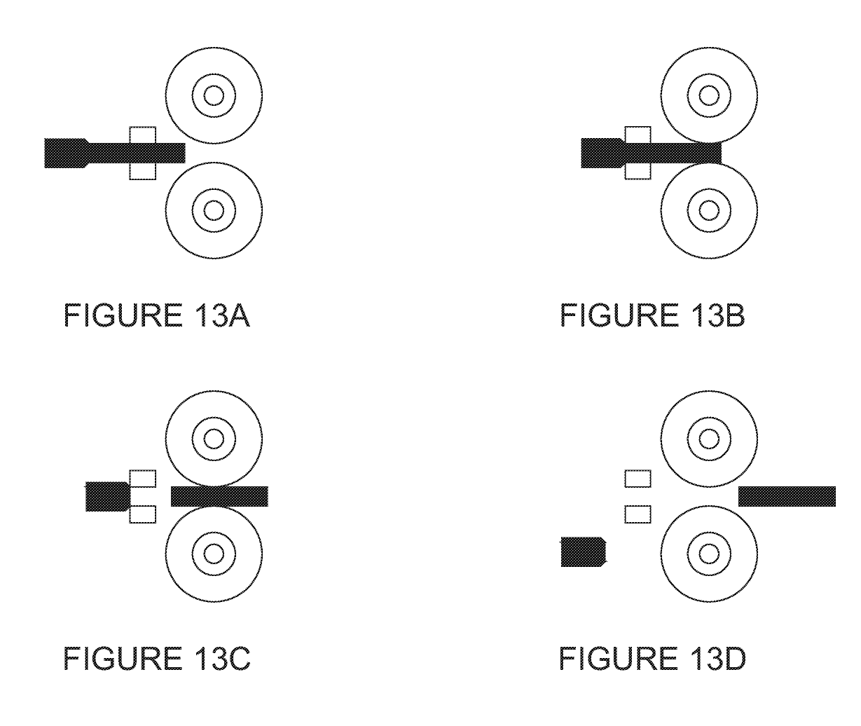

In some embodiments, and now turning to FIG. 13A to FIG. 13D, the use of the plant stem separating apparatus according to the embodiments described above for separating a stem from a larger upper portion of a plant, defining a stem separating process, will be described in more detail.

Briefly described, this process may comprise the steps of engaging the stem of the plant, conveying the stem of the plant through the engagement region, separating the stem from plant portions and ejecting the stem. More particularly, the first and second rollers rotate at a predetermined rotational speed such that, when the stem is captured by the first and second rollers, the stem is conveyed and pulled through a passage between the first and second rollers (in the engagement region) with a pulling force that is sufficient to shear the plant portions from the stem upon the plant portions entering in contact and being blocked by the blocking member.

In FIG. 13A, an engaging step is shown. In the engaging step, a plant including an upper portion having an upper diameter and a stem having a stem diameter is engaged into an aperture of appropriate diameter (i.e. the diameter of the stem is substantially the same as the diameter of the aperture). In the illustrated embodiment, the stem diameter is slightly smaller to the aperture diameter. The aperture is configured and sized to receive and allow passage of the stem therethrough, while the blocking member blocks passage of the plant portions.

In FIG. 13B, a conveying step is shown. In the conveying step, the stem of the plant is conveyed in the engagement region through the passage defined by the first and second rollers. At least during this step, the first and second rollers rotate around their respective axis at the rotational speed set by the controller.

In FIG. 13C, a separating step is shown. In the separating step, the stem of the plant is pulled by the first and second rollers, resulting in the separation of the plant portions from the stem of the plant. More particularly, the first and second rollers rotate at the rotational speed and, upon the capture of the stem between the first and second rollers, the stem is conveyed through the engagement region (between the first and second rollers) with the pulling force. The pulling force is sufficient to shear the plant portions from the stem, when the plant portions enter in contact with the blocking member and is blocked thereby.

In FIG. 13D, an ejecting step is shown. In the ejecting step, the plant portions fall upstream of the plant stem separating apparatus and the stem of the plant is ejected downstream of the plant stem separating apparatus.

The method and process described above may be useful for using the plant stem separating apparatus, and more particularly for disengaging and collecting plant portions without damaging them.

### Assembling Process

The assembling of the plant stem separating apparatus according to the embodiments, defining an assembling process, will be described in more detail.

In a placing step, the plant stem separating apparatus is placed onto a support base.

In an attaching step, the cutter comprising the apertures of varying dimensions is attached onto a support frame of the apparatus upstream of the first and second rollers, such that the apertures are aligned with the engagement region defined by the first and second rollers.

In a mounting step, the front chute is mechanically mounted to the support frame with affixing means such as bolts, screws, or any other elements allowing the front chute to be joined to the support frame. A sidewall of the support frame comprising an ejecting hole may also be mounted to the support frame.

A rear deflector may be provided and mounted downstream of the first and second rollers on the back portion of the plant stem separating apparatus, to downwardly deflect the stem.

In a placing step, a harvesting bin (also referred to as a receptacle) is placed upstream of the cutter, to catch the plant portions. The placing step may further include a sub-step of placing an ejecting bin downstream the first and second rollers and under the rear deflector, to catch the stripped stem.

The apparatus, method and process described herein can be used for disengaging a stem from plant portions extending from the stem, and can be applied to a broad variety of plants (e.g. flower, spices, hops, cannabis, or the like). The use of the disclosed apparatus facilitates the harvesting of leaves, flowers and/or buds without damaging the harvested leaves, flowers and/or buds. The plant stem separating apparatus is adapted to be suitable for plants presenting different characteristics (shape, size, humidity level, and the like).

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope defined in the appended claims.

1-66. (canceled)

67. A plant stem separating apparatus for separating a stem from upper plant portions extending from the stem, the plant stem separating apparatus comprising:
a cutter comprising a blocking member, the blocking member comprising a cutting plate and multiple apertures defined through the cutting plate, each aperture being sized for receiving the stem therethrough and the blocking member being positioned and configured for blocking a passage of the upper plant portions through the corresponding aperture, the multiple apertures having different dimensions;
a first roller having a first longitudinal axis and a first periphery defining a first conveying surface composed of rubber;
a second roller positioned below the first roller and having a second longitudinal axis and a second periphery defining a second conveying surface composed of rubber, the first conveying surface and the second conveying surface defining an engagement region therebetween downstream of the multiple apertures for receiving the stem, the multiple apertures being positioned in a spaced-apart relation with respect to the engagement region, the first and second rollers being positioned horizontally;
a motor for driving rotation of the first roller and the second roller, the first and second rollers being drivable to rotate in opposite directions in a forward feeding mode to grab the stem at the engagement region and pull the stem through the corresponding aperture, such that the upper plant portions are retained upstream of the blocking member while the stem is pulled through the corresponding aperture, thereby causing disengagement of the upper plant portions from the stem, the motor being operable to set a rotational speed; and
a transmission assembly coupled to the motor and the first and second rollers to transmit rotational movement from the motor to the first and second rollers, the transmission assembly comprising:
a motor gear or pulley coupled to a motor drive shaft;
a first roller gear or pulley coupled to the first roller;
a second roller gear or pulley coupled to the second roller; and
a drive loop coupled to the motor gear or pulley, the first roller gear or pulley, and the second roller gear or pulley, in order to transmit the rotational movement.

68. The plant stem separating apparatus of claim 67, wherein the drive loop comprises a drive belt.

69. The plant stem separating apparatus of claim 67, wherein the first and second rollers are vertically aligned such that the first longitudinal axis is directly above the second longitudinal axis; the first and second rollers have the same radius; and the cutting plate is spaced apart from the first and second rollers such that a distance from the engagement region to the cutting plate is greater than radius of the first and second rollers.

70. The plant stem separating apparatus of claim 67, further comprising a controller coupled to the motor and configured for controlling the rotational speed thereof, the controller comprising an adjustable knob for selecting a value of the rotational speed of the motor, and an activation switch for activating the motor.

71. The plant stem separating apparatus of claim 67, wherein the transmission assembly further comprises a supplementary gear or pulley mounted downstream of the first and second roller gears or pulleys, the drive loop being further operatively connected to the supplementary gear or pulley.

72. A plant stem separating apparatus for separating a stem from upper plant portions extending from the stem, the plant stem separating apparatus comprising:
a cutter comprising a blocking member, the blocking member comprising a cutting plate and a series of apertures defined through the cutting plate and aligned horizontally across a portion of the cutting plate, each aperture being sized for receiving the stem therethrough and the blocking member being positioned and configured for blocking a passage of the upper plant portions through the corresponding aperture;
a first roller and a second roller defining an engagement region therebetween downstream of each of the apertures for receiving the stem through a corresponding one of apertures, the first and second rollers being drivable to rotate in opposite directions in a forward feeding mode to grab the stem at the engagement region and pull the stem through the corresponding aperture, such that the upper plant portions are retained upstream of the blocking member while the stem is pulled through the aperture, thereby causing disengagement of the upper plant portions from the stem, the series of apertures being aligned with the engagement region and being generally parallel with longitudinal axes of rotation of the first and second rollers; and
a motor configured for driving rotation of at least one of the first roller and the second roller in the forward feeding mode.

73. The plant stem separating apparatus of claim 72, further comprising a transmission assembly coupled to the motor and the first and second rollers to transmit rotational movement from the motor to the first and second rollers.

74. The plant stem separating apparatus of claim 73, wherein the first roller and the second roller are respectively mounted on a first shaft and a second shaft that are aligned and in vertically spaced-apart relation to each other, and wherein the transmission assembly comprises:
a first gear coupled to the first shaft;
a second gear coupled to the second shaft;
a motor gear coupled to a motor shaft; and
a drive belt operatively connected to motor gear, the first gear and the second gear to transmit the rotational movement from the motor to the first and second rollers.

75. The plant stem separating apparatus of claim 74, wherein the transmission assembly further comprises a third gear, the drive belt being further operatively connected to the third gear.

76. The plant stem separating apparatus of claim 75, wherein the third gear is mounted downstream with respect to the first and second gears.

77. The plant stem separating apparatus of claim 75, wherein the first roller is positioned above the second roller, and wherein the drive loop comprises an outward side and an inward side and is configured such that the outward side engages around a portion of the first gear and the inward side engages around corresponding portions of the second gear, the supplementary gear and the motor gear.

78. The plant stem separating apparatus of claim 72, wherein at least one of the first conveying surface and the second conveying surface is composed of rubber.

79. The plant stem separating apparatus of claim 72, wherein the first conveying surface and the second conveying surface are composed of rubber.

80. The plant stem separating apparatus of claim 72, wherein the series of apertures comprises holes of different dimensions.

81. The plant stem separating apparatus of claim 72, further comprising a deflector mounted downstream of the first roller and the second roller, the deflector being configured for downwardly deflecting the stem after disengagement of the upper plant portions from the stem.

82. The plant stem separating apparatus of claim 72, further comprising a controller coupled to the motor and configured to control a rotational speed of the motor.

83. The plant stem separating apparatus of claim 82, wherein the controller comprises an adjustable knob for selecting a value of the rotational speed of the motor, and an activation switch for activating the motor.

84. The plant stem separating apparatus of claim 73, further comprising:
a support frame operatively connected to the motor, the first and second rollers, and the cutter; and
a cover connected to the support frame and configured to protect the transmission assembly.

85. A plant stem separating apparatus for separating a stem from upper plant portions extending from the stem, the plant stem separating apparatus comprising:
a support frame;
a driving assembly mounted to the support frame;
a controller operatively connected to the driving assembly for setting a rotational speed of the driving assembly;
a cutting plate comprising a plurality of apertures, each one of the plurality of apertures defining an inlet sized to receive and allow passage of the stem therethrough and block passage of the upper plant portions; and
a roller assembly mounted to the support frame downstream of the cutting plate, and operatively connected to the driving assembly, the roller assembly comprising:
a first cylindrical roller having a first longitudinal axis; and
a second cylindrical roller having a second longitudinal axis and being positioned below the first cylindrical roller, the first and second cylindrical rollers defining a passage therebetween, the stem being conveyable through the passage, the first cylindrical roller and the second cylindrical roller being drivable to rotate in opposite directions by the driving assembly about their respective first and second longitudinal axes at the rotational speed set by the controller, such that, upon capture of the stem between the first and second cylindrical rollers, the stem is conveyed through the passage between the first and second cylindrical rollers with a pulling force that is sufficient to shear the upper plant portions from the stem upon the upper plant portions entering in contact with the inlet and being blocked thereby.

86. The plant stem separating apparatus of claim 85, wherein at least one of the first cylindrical roller and the second cylindrical roller has an external surface composed of a resilient material.

87. The plant stem separating apparatus of claim 85, wherein the first cylindrical roller and the second cylindrical roller each have an external surface composed of a resilient material.

88. The plant stem separating apparatus of claim 88, wherein the resilient material comprise rubber.

89. The plant stem separating apparatus of claim 88, wherein the resilient material is configured to accommodate varying stem diameters passing through a same passage defined between the first and second cylindrical rollers.

90. The plant stem separating apparatus of claim 85, wherein the plurality of apertures is aligned horizontally across a portion of the cutting plate.

91. The plant stem separating apparatus of claim 85, wherein the plurality of apertures is at an elevation corresponding to that of the passage defined between the first and second cylindrical rollers.

92. The plant stem separating apparatus of claim 85, wherein the driving assembly comprises a motor coupled to the second cylindrical roller for driving rotation thereof.

93. The plant stem separating apparatus of claim 92, wherein the driving assembly comprises a supplementary motor coupled to the first cylindrical roller for driving rotation thereof.

94. The plant stem separating apparatus of claim 85, wherein the driving assembly comprises:
a motor for providing force for rotation; and
a transmission assembly coupled to the motor, the transmission assembly being operatively connected to at least one of the first cylindrical roller and the second cylindrical roller.

95. The plant stem separating apparatus of claim 94, wherein the first cylindrical roller and the second cylindrical roller are respectively mounted with respect to a first shaft and a second shaft that are aligned and in vertically spaced-apart relation to each other, the first shaft being directly above the second shaft.

96. The plant stem separating apparatus of claim 95, wherein the transmission assembly comprises:
a first transmission wheel coupled to the first shaft;
a second transmission wheel coupled to the second shaft;
a motor transmission wheel coupled to a motor shaft;
a supplementary transmission wheel mounted downstream of the first and second transmission wheels; and
a drive loop operatively connected to motor transmission wheel, the first transmission wheel, the second transmission wheel and the supplementary transmission wheel, to transmit the rotational movement from the motor to the first and second cylindrical rollers;
wherein the drive loop comprises an outward side and an inward side, and is configured such that the outward side engages around a portion of the first wheel unit and the inward side engages around corresponding portions of the second wheel unit, the supplementary wheel unit and the motor wheel unit.

97. The plant stem separating apparatus of claim 96, wherein the transmission wheels are gears.

98. The plant stem separating apparatus of claim 96, wherein the transmission wheels are pullies.

99. The plant stem separating apparatus of claim 85, wherein the apertures are beveled to aid insertion of the stem therethrough and facilitate separation of the upper plant portions from the stem.

100. The plant stem separating apparatus of claim 85, further comprising a front chute attached to the frame upstream of and below the cutting plate for collecting the upper plant portions after separation from the stem.

101. The plant stem separating apparatus of claim 85, wherein each of the apertures has a circular shape.
